(19) United States
(12) Patent Application Publication
(10) Pub. No.: US 2013/0196419 A1
(43) Pub. Date: Aug. 1, 2013

(54) BIOCEMENTATION OF PARTICULATE MATERIAL IN SUSPENSION

(71) Applicant: Cultivos Hidrobiologicos y Biotecnologia Aguamarina S.A., Antofagasta (CL)

(72) Inventors: Pamela Chavez Crooker, Antofagasta (CL); Jeannette Marisol Vera Araya, Antofagasta (CL); Pamela Gutierrez Saldano, Antofagasta (CL); Johanna del Rosario Obreque Contreras, Antofagasta (CL)

(73) Assignee: Cultivos Hidrobiologicos y Biotecnologia Aguamarina S.A., Antofagasta (CL)

(21) Appl. No.: 13/753,875

(22) Filed: Jan. 30, 2013

(30) Foreign Application Priority Data
Jan. 30, 2012 (CL) 0241-2012

(51) Int. Cl. C02F 3/34

(52) U.S. Cl. CPC C02F 3/34
USPC 435/252.4; 210/601; 435/266

(57) ABSTRACT

The present invention is directed to a composition and method to decrease the amount of particulate material in suspension, both in a liquid or in air, especially in industrial processes that generate suspended particulate material. In particular, the invention is directed to a composition and method to decrease the amount of particulate material in suspension in air or a liquid through agglomeration and subsequent biocementation, by application of an exopolysaccharide (EPS) source that can be direct or through inoculation with microorganisms that produce said EPS. This allows in a first step to settle the particulate material and subsequently the cementation of the material when there are calcium containing compounds in the particulate material that has been settled in the first step, by means of the inoculation of a second class of microorganisms that have ureolytic activity.

### REFERENCE TO RELATED APPLICATION

This application claims the benefit of Chilean Patent Application No. 0241-2012, filed Jan. 30, 2012, which is hereby incorporated by reference.

### TECHNICAL FIELD

The present invention is directed to a composition and method to decrease the amount of particulate material in suspension, both in a liquid or in air, especially in industrial processes that generate suspended particulate material.

In particular, the invention is directed to a composition and method to decrease the amount of particulate material in suspension in air or a liquid through agglomeration and subsequent biocementation, by application of an exopolysaccharide (EPS) source that can be direct or through inoculation with microorganisms that produce said EPS. This allows in a first step to settle the particulate material and subsequently the cementation of the material when there are calcium containing compounds in the particulate material that has been settled in the first step, by means of the inoculation of a second class of microorganisms that have ureolytic activity.

### STATE OF THE ART

There are microorganisms known by the production and release into the growing medium of polysaccharides or exopolysaccharides with particular properties, such as, for instance, a net charge. Said exopolysaccharides (EPS) are produced by many and varied types of microorganisms, and also their composition is varied. In general terms, exopolysaccharides are biopolymers produced by some microorganisms and secreted into the extracellular space, which are formed by monomeric sugar residues linked to form the main structure. These monomers can or cannot be substituted by groups such as acetate, pyruvate, succinate, sulfate or phosphate, for instance. In this way, depending on their composition, EPS can have a net charge, which can be either negative or positive, and be present in a higher or lower degree.

Additionally, there are microorganisms known in the art to allow precipitation of carbonates with an excess of calcium ions to form calcite (CaCO3) in situ and in this way under suitable conditions the material is solidified in a process known as biocementation.

For instance, the Patent CN1923720A filed on 2006 is directed to the use of strains of Bacillus pasteurii to precipitate heavy metal complexes such as Cu, Cd, Pb, Zn, and microorganisms, also generating the precipitation of carbonates. The described method requires the addition of calcium Ca2+ ions to generate said precipitation. However, it does not describe the use of microorganism strains or the use of exopolysaccharides that allow a first step of settling and a subsequent cementation, as described by the present invention.

The U.S. Pat. No. 6,562,585 describes the purification of contaminated bodies of water, in particular for reduction of organo-nitrous or nitrate compounds, as well as for decreasing ammonia, nitrites and nitrates in water. The mentioned microorganisms correspond to bacteria belonging to the genus Bacillus, in particular B. pasteurii. However, the document does not describe the biocementation or solidification of settled material, as well as the use of exopolysaccharides or microorganisms that produce exopolysaccharides as described by the present invention.

The Master of Sciences degree thesis titled “Ureolytic CaCO3 precipitation for immobilization of arsenic in an aquifer system” of Jennifer Arnold, presented on 2007 at the Saskatchewan University of Canada describes the precipitation of carbonates in underground waters using inocula of microorganisms with ureolytic properties. In particular, the decrease of arsenic in the treated water, indicating the particular calcium concentrations that have to be present in the culture media for the precipitation to be successful is described. However, said publication does not describe the use of exopolysaccharides or microorganisms that produce exopolysaccharides to settle the suspended material in a first step, as described by the present invention.

Additionally, the publication “Applications of microorganisms to geotechnical engineering for bioclogging and biocementation of soil in situ”, Rev Environ SciBiotechnol, of Volodymyrlvanov and Jian Chu, 2008, describe the use of B. pasteurii in the formation of clods in a medium containing urea and calcium chloride. However, the biocementation together with the precipitation produced by using exopolysaccharides or microorganisms that produce exopolysaccharides is not described.

The publication WO2006066326 describe the formation of a cement from a permeable material by means of the inoculation with microorganisms with ureolytic properties together with a culture medium rich in urea and calcium ions, in particular with a B. pasteurii strain. However, this document does not describe the biocementation together with an improved precipitation obtained through the use of exopolysaccharides or microorganisms that produce exopolysaccharides.

None of the documents of the state of the art describes the combination of exopolysaccharides or microorganisms that produces exopolysaccharides with at least one strain of microorganisms that have ureolytic properties that allow precipitating carbonates.

### BRIEF DESCRIPTION OF THE INVENTION

The present invention is directed to a method and composition of microorganisms that allow biocementation of particulate material suspended in air or water from an aqueous suspension. The method comprises the addition of a culture medium with the presence of a polysaccharide source, wither directly isolated or by means of an inoculum with an exopolysaccharide-producing microorganism strain that allow initially precipitating and agglomerating the suspended particulate material, and a second type of microorganisms with ureolytic properties that allows precipitating carbonates to generate the biocementation and compaction of the precipitated material.

### BRIEF DESCRIPTION OF THE DRAWINGS

FIG. 1. Sedimentation of particulate material in air. The figure shows the amount of material settled in grams. The assay was carried out from 10 grams of particulate material in each case, with 2 ml of culture medium containing the bacteria SLIM, B. pasteurii, both, medium without bacteria or water as a control.

FIG. 2. The figure shows a precipitate generated by the bacterium B. pasteurii in a medium together with SLIM bacteria. This white precipitate is only observed in the presence of B. pasteurii.

FIG. 3. Assay of the different culture media inoculated with the bacterium Bacillus pasteurii. a) Medium B+CaCl₂+Salts+Suspended materials; b) Medium B+Salts+Suspended materials; c) Medium B+Salts; d) Medium B; e) Medium B+CaCl₂.

FIG. 4. Micrography of the culture medium of the bacterium B. pasteurii with the particulate material. (A) shows a crystal formed from the particulate material, (B) shows agglomerated material that will form crystals and (C) shows a B. pasteurii bacillus.

FIG. 5. Samples analyzed by SEM of the sedimentation carried out by the bacteria. The figure shows different forms of crystals produced by the bacteria using as a substrate the particulate material.

FIG. 6. A) In this assay, the bacteria were grown in a complete medium also containing 0.1 g of CaCl₂ and 0.1 g of calcium arsenate. The figure shows a grayish precipitate formed by the bacteria. The three rightmost tubes show the experiment carried out by triplicate; at the left, the figure shows the triplicate experiment with bacteria grown with and without stirring. B) In this assay, the bacteria were grown in a complete medium only containing 0.2 g of calcium arsenate. The figure shows a small amount of grayish precipitate formed by the bacteria using only calcium arsenate as a source of calcium. The three rightmost tubes show the experiment carried out by triplicate; at the left, the figure shows the triplicate experiment with bacteria grown with and without stirring. C) In this assay, the bacteria were grown in a complete medium with no calcium source (without CaCl₂ or calcium arsenate).The figure shows no precipitate formed by the bacteria. The three rightmost tubes show the experiment carried out by triplicate; at the left, the figure shows the triplicate experiment with bacteria grown with and without stirring. D) In this assay, the bacteria were grown in a complete medium that also contains 0.2 g of CaCl₂ with no calcium arsenate. The figure shows a white precipitate formed by the bacteria. The three rightmost tubes show the experiment carried out by triplicate; at the left, the figure shows the triplicate experiment with bacteria grown with and without stirring.

FIG. 7. Experiment in a dish with the calcium arsenate sample to be immobilized using B. pasteurii bacteria. A) Dishes with granulated material (GM) 24 hours after the first inoculum. B) Dishes with fine particulate material (PM) 24 hours after the first inoculum. C) Dishes with GM 72 hours after the first inoculum. D) Dishes with PM 72 hours after the first inoculum. E) Dishes with GM 7 days after the first inoculum. F) Dishes with PM 7 days after the first inoculum.

FIG. 8. Experiment using the composition of the invention with the particulate material for the formation of compact blocks. A) Blocks solidified in a tray. B) Blocks of firmly compacted material.

### DETAILED DESCRIPTION OF THE INVENTION

The present invention is directed to a composition comprising a) a source of polysaccharides (EPS) and b) a strain of microorganisms with ureolytic activity. The EPS source a) can be directly EPS or a strain of EPS producing microorganisms. The invention is also directed to the method that allows generating the biocementation of the suspended material, both in air as in a liquid medium.

In a preferred embodiment, the exopolysaccharide source (EPS) correspond to a microorganism strain, which can be bacteria or microalgae, characterized by producing EPS.

In particular, the microorganism composition of the present invention can comprise one or more different microorganism strains of each type.

Preferably, the EPS producing microorganisms produce exopolysaccharides with a negative net charge that allow the agglomeration and settling of the particulate material in suspension, although positively charged EPS can also be used.

Regarding the microorganisms having ureolytic activity, any microorganism type with a suitable ureolytic activity can be used.

Without limiting the invention, and only with the aim of presenting an exemplary embodiment, a particular exopolysaccharide (EPS) producing microorganism is mentioned, i.e. the slime producing bacteria SLIM, microalgae of the species Nitzschia sp. or other slime or EPS producing microalgae.

In the present description, the term “slime producing SLIM bacteria” as one of the diverse microorganisms that produce large amounts of EPS during their growth and able to form biofilms. In general, these are bacteria that form colonies and they produce slime by themselves, live in humid soil or rotting vegetal material or animal wastes. For instance, without limiting the invention, slime producing microorganisms have been isolated from stainless steel corrosion sites, such as Clostridium spp., Flavobacterium spp., Bacillus spp., Desulfovibrio spp., Desulfotomaculum spp. and Pseudomonas spp., but the present invention is not limited to these specific microorganisms since in the present invention any slime producing microorganism strain can be used, which are generically known as SLIM.

Without limiting the invention, in the following sections a particular microorganism is described, Bacillus pasteurii, which has a well assessed ureolytic activity.

The bacterium Bacillus pasteurii is able to turn sand, mainly composed of silicon oxide, in solid sandstone in the term of one week. This reaction is stable in time. Furthermore, this bacterium is not a human pathogen and dies in the sand solidification process.

Bacillus pasteurii is an aerobic bacterium that is infiltrated in natural humid soil deposits, where it generates calcite from calcium carbonate available in the medium, and thus is able to form large aggregates of sand granules.

The method of the present invention corresponds to the application of a liquid containing:
a) An exopolysaccharide source (EPS);
b) A microorganism strain with ureolytic activity;
c) Culture medium;

The EPS source can be directly EPS obtained and isolated from an EPS producing microorganism culture, or an EPS producing microorganism strain, said microorganisms containing said EPS in the moment of application.

In the case where the EPS source are EPS obtained and isolated from an EPS producing microorganism culture, the EPS are present at a concentration between 0.5 and 5% in the final composition.

In the case that the EPS source is a microorganism strain, the culture medium will be adjusted to the nutritional requirements of the strains comprising the composition of the invention. For the preparation of the composition of the invention, the culture of the EPS producing microorganism strain must be in the stationary phase with a concentration ranging from 10⁷ to 10⁹ cells per ml, more preferably around 10⁸ cells per ml.

In a particular embodiment, when the selected EPS source is an EPS producing microorganism, the final concentration of EPS producing microorganisms in the composition of the invention ranges from 10⁶ to 10⁸ cells per ml.

The final concentration of ureolytic microorganisms in the composition of the invention ranges from 10⁶ to 10⁸ cells per ml.

The composition of the invention uses culture medium to complete the volume of the composition, in such a way as to get the previously described concentrations of microorganisms.

Particularly, the culture medium should contain:

urea, a protein source, sodium chloride, ammonium chloride, sodium bicarbonate and calcium chloride. In a particular embodiment, without limiting the scope of the invention, the culture medium comprises:

| CHEMICAL | GRAMS |
|---|---|
| Yeast extract | 10 |
| Bacteriological peptone | 20 |
| Glucose | 10 |
| Calcium carbonate | 10 |
| Calcium chloride | 10 |
| Distilled water | Required amount to |
| | complete 1000 ml |

In a particular example, without limiting the scope of the invention, 2.5 ml of inoculum of an EPS producing strain with a concentration of 10⁸ microorganisms per ml, and a 2.5 ml inoculum of a strain with ureolytic activity with a concentration of 10⁸ microorganisms per ml. The mixture is completed with culture medium up to a final volume of 20 ml.

The method comprises the steps of:
a) Applying the composition of the invention to a suspended solid (particulate material in air) or to a liquid containing particulate material;
b) Allowing the particulate material to settle as a consequence of the EPS action;
c) Allowing the biocementation as a consequence of the action of ureolytic microorganisms;
d) Obtaining a solid compact block resistant to external pressure.

When the particulate material is suspended in air, the application is carried out by spraying. In the case of a particulate material in suspension in a liquid, the composition is added to the liquid.

In particular, steps b) and c) can occur simultaneously or sequentially.

The application of the composition is carried out by addition in a proportion ranging from 0.001 to 0.01 g/l, preferably 0.005 g/l with respect to the volume of liquid containing the particulate material to be treated.

The settling times occur immediately, ranging from 1 to 30 minutes, preferably 10 minutes, counted from the moment in which the composition of the invention is applied, while the biocementation process occurs between 24 to 72 hours counted from the application of the composition of the invention.

The final product, after the composition allows the decantation and biocementation of the suspended particulate material, is a solid compact block resistant to external pressures.

### EXAMPLES

### Example 1

Settling assays of Bacillus pasteurii bacteria in the presence of EPS producing bacteria.

These assays demonstrate that in fact cementation occurs together with the application of B. pasteurii bacteria in the particulate material cementation process, after the settling of the particulate material caused by the EPS produced by SLIM bacteria.

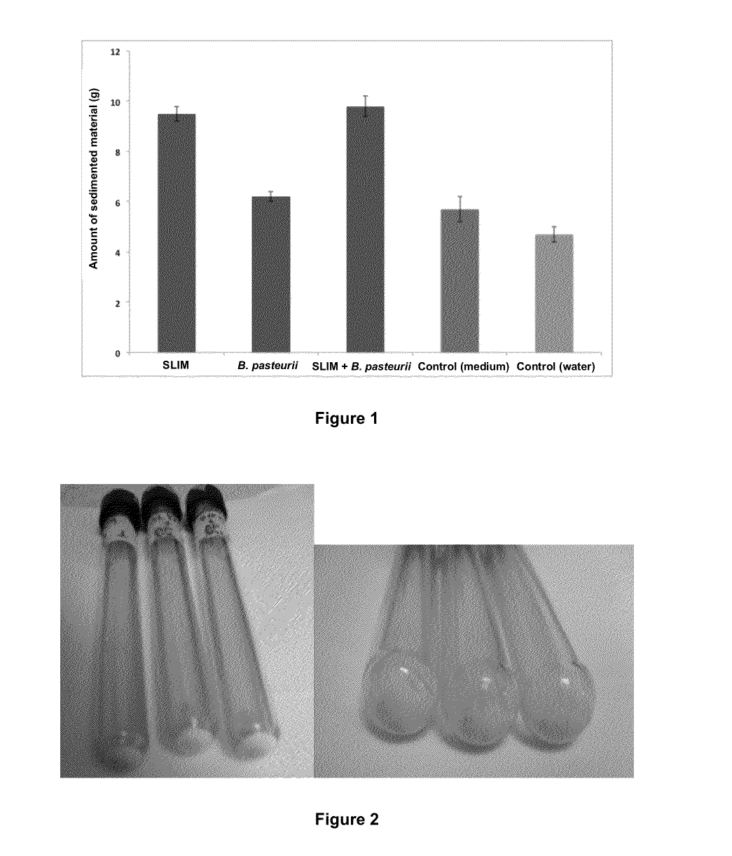

Firstly, both microorganisms (SLIM bacteria and B. pasteurii) are cultured and the efficiency of the SLIM bacteria to settle the suspended particulate material is assayed. The results show that the SLIM bacteria keep the settling properties in the presence of B. pasteurii bacteria, with no significant differences when the SLIM bacteria are cultured alone or in the presence of B. pasteurii. (FIG. 1).

| | Amount of settled material |
|---|---|
| Bacteria | (grams) |
| SLIM | 9.5 |
| B. pasteurii | 6.2 |
| SLIM + B. pasteurii | 9.8 |
| No bacteria | 5.7 |
| No bacteria | 4.7 |

Sedimentation of particulate material in air. FIG. 1 shows the amount of material settled in grams. The assay was carried out from 10 grams of particulate material in each case, with 2 ml of culture medium containing the bacteria SLIM, B. pasteurii, both, medium without bacteria or water as a control.

Once the efficiency of SLIM bacteria for settling the particulate material in the presence of B. pasteurii was demonstrated, the ability of B. pasteurii to cement calcium carbonate in the presence of SLIM bacteria was assayed.

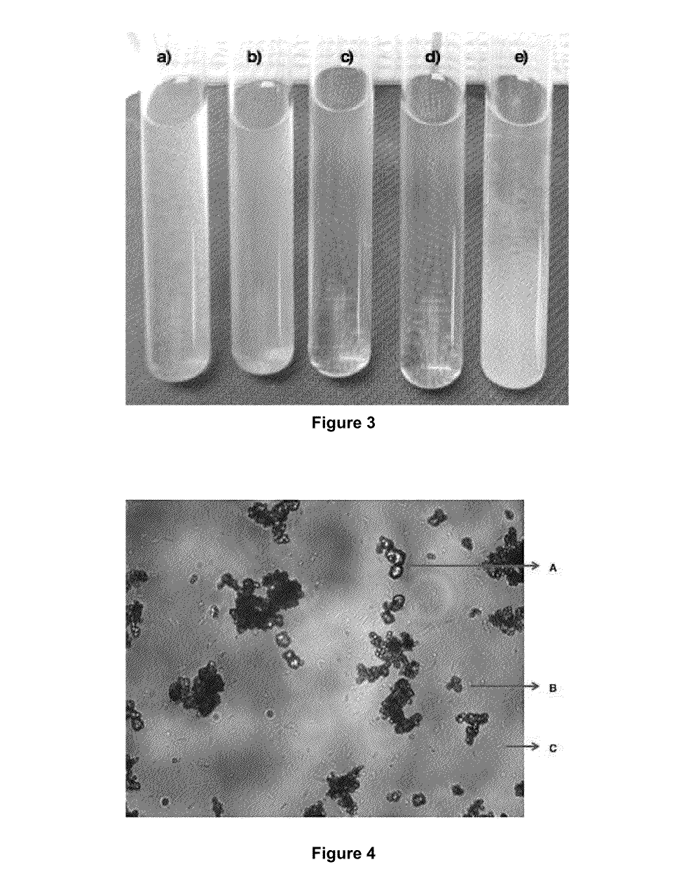

The results demonstrate that B. pasteurii maintains the cementation efficiency even in the presence of the SLIM bacteria (FIG. 2).

This result demonstrates that both bacteria can coexist in the same medium and maintain their properties.

The use proposed for this invention is settling suspended material through the activity of SLIM bacteria and a subsequently cementing the settled material through the activity of B. pasteurii bacteria. Therefore, the suspended particulate material can be controlled and compacted in a single step.

### Example 2

Experiments with B. pasteurii and SLIM bacteria on particulate material.

The feasibility of precipitating particulate material through the use of Bacillus pasteurii was assayed. For this aim, we used a DSMZ bacterial strain with code number 33 isolated from soil.

This freeze dried bacteria were resuspended and cultured in culture medium (Medium B) comprising per each liter: 20 g urea, 5 g casein, 5 g sodium chloride, 2 g yeast extract and 1 g meat extract. pH was adjusted to 7.4 and the culture was kept at 25° C.

After achieving an optimal bacterial growth, settling assays were carried out testing different culture conditions:
a) Medium B+CaCl₂+Salts+Suspended materials
b) Medium B+Salts+Suspended materials
c) Medium B+Salts
d) Medium B
e) Medium B+CaCl₂

2 ml of bacteria of each type, B. pasteurii and SLIM bacteria, with a growth of 10⁸ were added to each 10 ml tube.

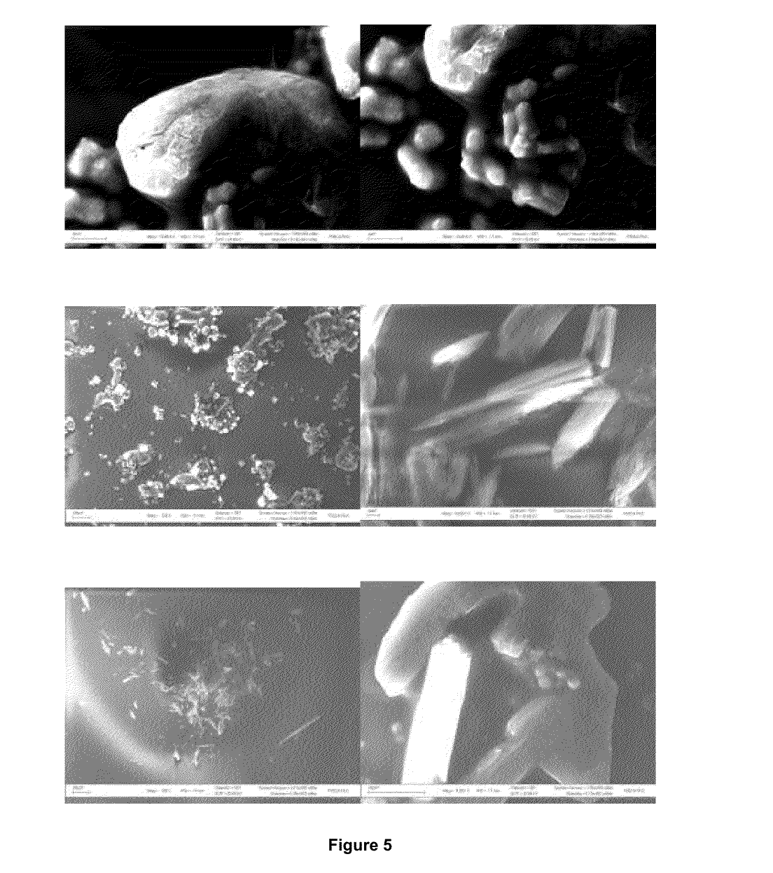

After 4 days, the culture was examined; the results are shown in FIG. 3.

Assay of the different culture media inoculated with Bacillus pasteurii.

The results show the formation of a precipitate in the tubes containing the particulate material a) and b), and also in the tube e) containing calcium chloride as a positive control. In the tubes where there is no particulate material or calcium chloride c) and d), no precipitation of material is observed and the liquid remains translucent.

These results demonstrate that B. pasteurii bacteria are highly effective to agglomerate and settle the particulate material.

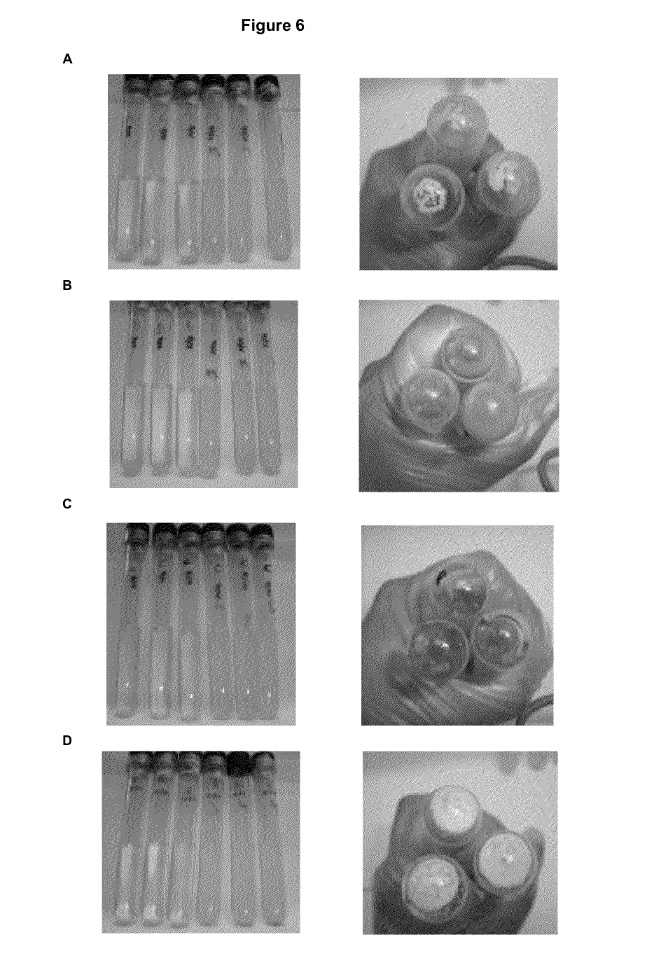

In other assays, similar results were obtained with the bacteria faced to suspended material consisting of powder from mining works. FIG. 4 shows a micrograph obtained after 4 days of culture of the bacteria with the particulate material.

FIG. 4 shows bacteria with a bacillary shape, which generate the agglomeration of the material, and also shows compact crystals formed by agglomeration of the particulate material.

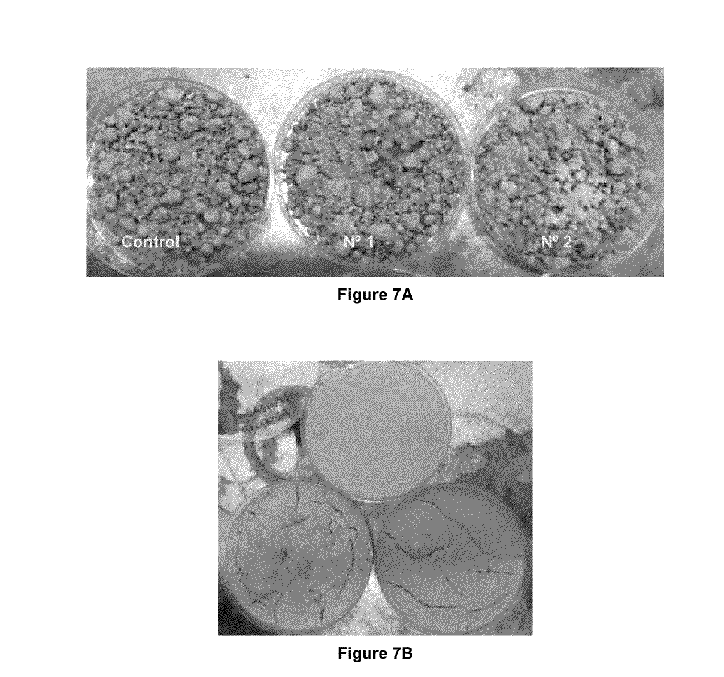

Scanning electron microscopy (SEM) assays have been also carried out for the samples of the culture media containing particulate material (FIG. 5).

### Example 3

Experiments with Bacillus pasteurii, SLIM bacteria and calcium arsenate.

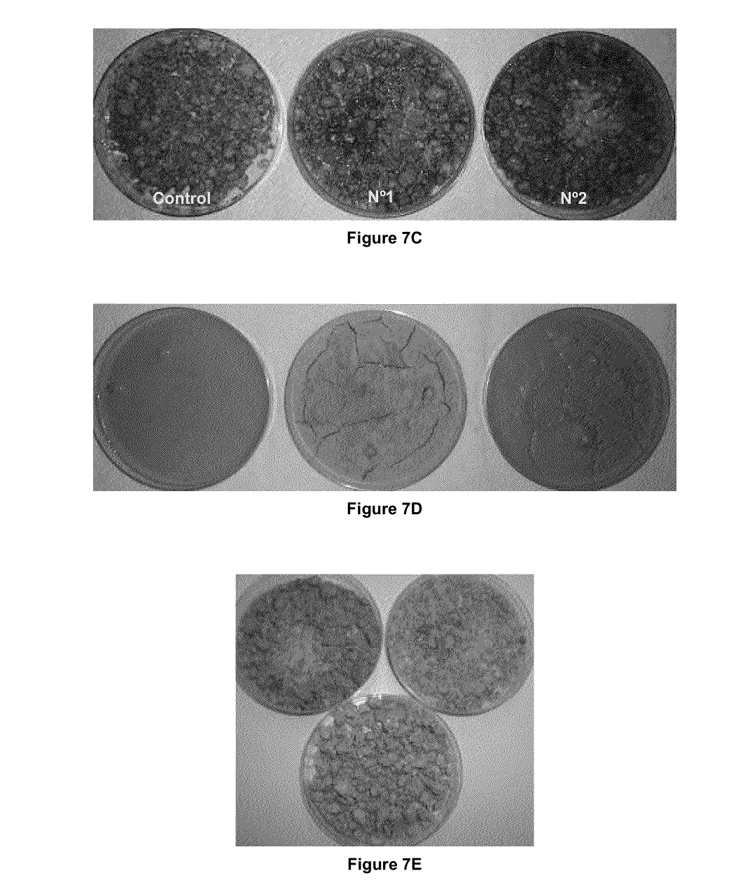

The feasibility of precipitating calcium arsenate using B. pasteurii and an initial settling with SLIM bacteria was assayed. For this, diverse assays were carried out using bacteria resuspended and cultured in culture medium (Medium B, described in Example 2). After an optimal culture in suitable culture conditions, the following assays were carried out modifying the culture media (FIG. 6).
A. Medium B+CaCl₂+Calcium arsenate
B. Medium B+Calcium arsenate
C. Medium B
D. Medium B+CaCl₂

A. In this assay, the bacteria were grown in a complete medium also containing 0.1 g of CaCl₂ and 0.1 g of calcium arsenate. The figure shows a grayish precipitate formed by the bacteria. The three rightmost tubes show the experiment carried out by triplicate; at the left, the figure shows the triplicate experiment with bacteria grown with and without stirring.

B. In this assay, the bacteria were grown in a complete medium only containing 0.2 g of calcium arsenate. The figure shows a small amount of grayish precipitate formed by the bacteria using only calcium arsenate as a source of calcium. The three rightmost tubes show the experiment carried out by triplicate; at the left, the figure shows the triplicate experiment with bacteria grown with and without stirring.

C. In this assay, the bacteria were grown in a complete medium with no calcium source (without CaCl₂ or calcium arsenate). The figure shows no precipitate formed by the bacteria. The three rightmost tubes show the experiment carried out by triplicate; at the left, the figure shows the triplicate experiment with bacteria grown with and without stirring.

D. In this assay, the bacteria were grown in a complete medium that also contains 0.2 g of CaCl₂ with no calcium arsenate. The figure shows a white precipitate formed by the bacteria. The three rightmost tubes show the experiment carried out by triplicate; at the left, the figure shows the triplicate experiment with bacteria grown with and without stirring.

These experiments show that B. pasteurii is able to precipitate calcium carbonate in the presence of calcium chloride and also in the presence of other calcium sources, such as calcium arsenate.

Another experiment was made in a dish with the calcium arsenate sample to be immobilized using B. pasteurii bacteria.

The sample was worked under two conditions:

1.—A solid sample is collected and placed in a Petri dish, where freshly inoculated culture medium (CM; 4 ml CM and 2 ml inoculum per dish) is applied.

2.—A solid sample is collected and mixed with freshly inoculated culture medium (2:1 in volume) until a paste is formed, which is poured in the Petri dish.

Samples were left under an extractor hood, covered and with drying paper to favor evaporation and avoid contamination.

The culture medium was prepared with the stoichiometric amount of CaCl₂ with respect to urea, according to the following reaction:

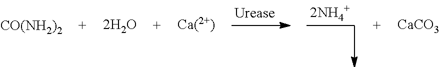

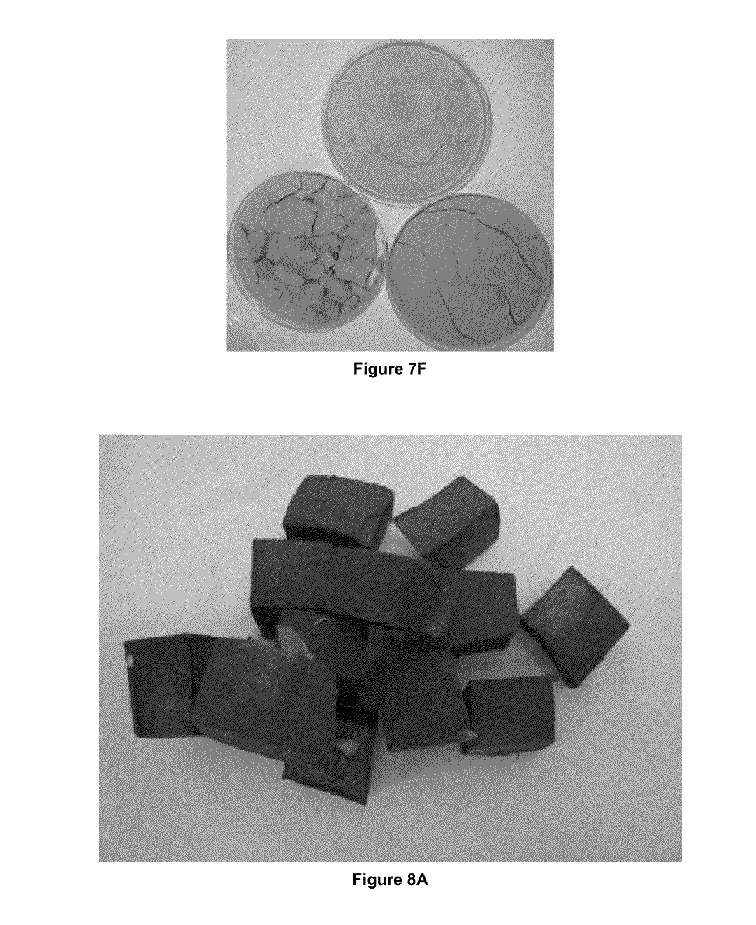

Results:
1. Dishes with granulated material (GM) 24 hours after the first inoculum (FIG. 7A)
   White zones are observed, which can be attributed to CaCO₃ precipitation.
   After this observation, freshly inoculated culture medium (4 ml CM and 2 ml inoculum per dish) is sprayed again on the dish.
2. Dishes with fine particulate material (PM) 24 hours after the first inoculum (FIG. 7B)
   Dishes with the inoculated material were drier; the control (top) shows no differences from the beginning of the experiment. Dishes inoculated with bacteria (bottom) show cracking and a compact appearance; sample 1 is left without spraying culture medium, and sample 2 is sprayed with 4 ml CM and 2 ml inoculum.
3. Dishes with GM 72 hours after the first inoculum (FIG. 7C)
   The control is drier and samples 1 and 2 show a more compact material block, product of the precipitation of CaCO₃.
4. Dishes with PM 72 hours after the first inoculum (FIG. 7D)
   The control still has water on the surface and its consistency is still paste-like. Sample 1 is dry and has a more pronounced cracking, and sample 2, which was sprayed on day 1, is wet only in the surface and also shows cracking.
5. Dishes with GM 7 days after the first inoculum (FIG. 7E)
   The samples are quite dry. In samples 1 and 2 (top section), the particles on the surface are bound and form a compact mass that is not fragmented. The control (bottom dish) changed color by water loss, and loose particles are observed on the surface. There is no compaction in this case and the sample is also not adhered to the dish.
6. Dishes with PM 7 days after the first inoculum (FIG. 7F)
   The samples are drier. The control sample (top) is still wet and is soft to the touch. Samples with bacteria (bottom) are fragmented as a product of their solidification and their consistence is much firmer.

### Example 4

Experiment using the composition of the invention with the particulate material for the formation of compact blocks.

With the results obtained in the previous example, another experiment was carried out with the aim of standardizing the optimal growth conditions of bacteria to get compact blocks formed from the particulate material.

Equal amounts of powder and di-hydrated chloride were weighed, added to the culture medium and stirred, thus obtaining a viscous paste.

Once a homogeneous paste was obtained, an inoculum is added and the tray is filled for cube formation.

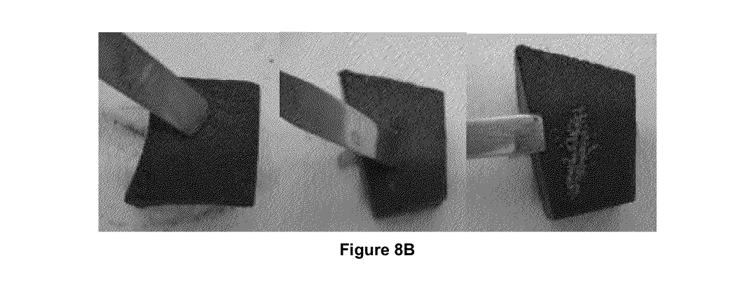

After 6 culture days, solidified blocks are detached from the tray (FIG. 8A). FIG. 8B shows firmly compacted material blocks.

FIG. 8B shows an image sequence illustrating the hardness of the block formed by the bacteria, which is eroded with a metallic spatula.

Furthermore, the permeability of the compacted sample was assayed. The assays show that the blocks are not able to absorb water. Contrarily, with the salt content of the block, this changes its weight as long as it is confronted to water.

When the block was entirely submerged in water, it lost 28% of its initial weight. When the block was exposed to a continuous water flow (100 ml), it lost 25% of its initial weight. This indicates that blocks are waterproof and are not able to retain water within, but they can only lose weight.

1. A composition to decrease the amount of particulate material suspended in air or a liquid wherein said composition comprises:
a. an exopolysaccharide source (EPS);
b. a microorganism strain with ureolytic activity at a concentration ranging from 10⁶ to 10⁸ microorganisms per ml in the final composition; and
c. culture medium.

2. A composition to decrease the amount of particulate material suspended in air or a liquid according to claim 1 wherein the exopolysaccharide source is EPS obtained and isolated from a culture of EPS producing microorganisms, and EPS are present at a concentration ranging from 0.5 to 5% in the final composition.

3. A composition to decrease the amount of particulate material suspended in air or a liquid according to claim 1 wherein the exopolysaccharide source corresponds to a viable slime producing microorganism strain.

4. A composition to decrease the amount of particulate material suspended in air or a liquid according to claim 3 wherein the slime producing microorganisms are SLIM bacteria at a concentration ranging from 10⁶ to 10⁸ microorganisms per ml in the final composition.

5. A composition to decrease the amount of particulate material suspended in air or a liquid according to claim 3 wherein the slime producing microorganisms are microalgae at a concentration ranging from 10⁶ to 10⁸ microorganisms per ml in the final composition.

6. A composition to decrease the amount of particulate material suspended in air or a liquid according to claim 1 wherein the microorganism with ureolytic activity is a culture of Bacillus pasteurii.

7. A method to decrease the amount of particulate material suspended in air or a liquid wherein said method comprises the steps of:
a. applying a composition that comprises an exopolysaccharide (EPS) source, a strain of microorganisms with ureolytic activity and culture medium, to a suspended solid (particulate material in air) or to a liquid containing particulate material;
b. allowing the particulate material to settle as a consequence of the EPS action;
c. allowing the biocementation as a consequence of the action of ureolytic microorganisms;
d. obtaining a solid compact block resistant to external pressure.

8. A method to decrease the amount of particulate material suspended in air or a liquid according to claim 7 wherein steps b) and c) can occur simultaneously or sequentially.

9. A method to decrease the amount of particulate material suspended in air or a liquid according to claim 7 wherein when the particulate material is suspended in air the application is carried out by spraying, and when the particulate material is suspended in a liquid, the composition is added to the liquid.

10. A method to decrease the amount of particulate material suspended in air or a liquid according to claim 7 wherein the application of the composition comprises adding a proportion ranging from 0.001 to 0.01 g/l, preferably 0.005 g/l with respect to the volume of liquid with particulate material to be treated.

11. A method to decrease the amount of particulate material suspended in air or a liquid according to claim 7 wherein settling times in step b) occur immediately, from 1 to 30 minutes, preferably 10 minutes, counted from the moment when the composition of the invention is applied.

12. A method to decrease the amount of particulate material suspended in air or a liquid according to claim 7 wherein the biocementation process in step c) occurs between 24 to 72 hours counted from the application of the composition of this invention.
